(19) United States
(12) Patent Application Publication
(10) Pub. No.: US 2022/0374671 A1
(43) Pub. Date: Nov. 24, 2022

(54) RFID TAG WITH SHIELDING CONDUCTOR FOR USE IN MICROWAVEABLE FOOD PACKAGES

(71) Applicant: DIGITAL TAGS FINLAND OY, Tampere (FI)

(72) Inventors: Lauri HUHTASALO, Tampere (FI); Ilkka YLI-PELTOLA, Kangasala (FI)

(73) Assignee: DIGITAL TAGS FINLAND OY, Tampere (FI)

(21) Appl. No.: 17/770,892

(22) PCT Filed: Oct. 20, 2020
(86) PCT No.: PCT/IB2020/059848

§ 371 Date: Apr. 21, 2022

(30) Foreign Application Priority Data
Oct. 21, 2019 (SE) 1951190-6

(51) Int. Cl. G06K 19/07; H01Q 9/06; H01Q 1/22; G06K 19/077

(52) U.S. Cl. CPC G06K 19/0723; H01Q 9/065; H01Q 1/2208; G06K 19/07773

(57) ABSTRACT

An RFID tag is disclosed comprising a dielectric substrate having a first side and an opposite second side, and with an antenna arranged on the first side of the dielectric substrate. The antenna defines a gap and is configured to operate at an operation frequency. The RFID tag further comprises an RFID chip electrically coupled to the antenna across the gap. A shielding conductor is arranged on the second side of the dielectric substrate, and preferably underlaying the gap, wherein the shielding conductor is configured to limit the voltage across the gap when the antenna is exposed to a microwave frequency of a microwave oven.

### TECHNICAL FIELD OF THE INVENTION

The present invention is related to a radio frequency identification (RFID) tag. The RFID tag is arranged to be useable in a microwave oven, and may for example be arranged on or incorporated in a microwaveable food package or food item. The invention further relates to a packaging for a microwaveable food item comprising such an RFID tag.

### BACKGROUND

RFID tags are nowadays used more and more frequently, and for a wide variety of applications, such as in smart labels/tags. The RFID tag is conventionally arranged as a flat configured transponder, e.g. arranged under a conventional print-coded label, and includes a chip and an antenna. The labels/tags are often made of paper, fabric or plastics, and are normally prepared with the RFID inlays laminated between a carrier and a label media, e.g. for use in specially designed printer units. Smart labels offer advantages over conventional barcode labels, such as higher data capacity, possibility to read and/or write outside a direct line of sight, and the ability to read multiple labels or tags at one time.

It is also known to incorporate RFID labels directly in a packaging material, to form so-called intelligent packaging products.

One application for RFID tags which is becoming increasingly interesting is in packages comprising food and the like intended for microwave heating in microwave ovens. The RFID tag can hereby be used e.g. for logistics tracking purposes and the like. However, typically food and the like intended for microwave heating are cooked or heated in the microwave oven without removal of the food container package. The package may even be part of the cooking process.

During the heating or cooking in the microwave oven, the RFID functionality is no longer needed and used, and the RFID tag may be removed prior to placement in the microwave oven. However, removal of the RFID tag may be cumbersome and difficult, and may also easily be forgotten.

Exposure of RFID tags to microwaves in a microwave oven may, however, lead to a concentrated heating, which may lead to safety risks. RFID tags have a gap across which the RFID chip is placed. The power received by the RFID tag from a conventional reader device is generally low, in the order of a few microwatts, whereas a microwave oven may typically operate at a power level in excess of 800 watts, which can generate very high voltages across the gap. Further, RFID antennas are commonly designed to operate at a UHF frequency, for example in the range of approximately 860 MHz to 930 MHz, with the antenna receiving incident power from an RFID reader and converting it to a voltage across the RFID chip to allow it to operate. A microwave oven, on the other hand, typically operates at a higher frequency, typically in the order of approximately 2,450 MHz. When exposed to microwaves in a microwave oven, the microwaves will also be incident on the antenna of the RFID tag. The very high power levels and frequency of these microwaves will generate high voltages on the antenna, and in particular over the gap bridged by the RFID chip, since this gap is necessarily relatively small, typically in the range 100-200 μm. This high voltage may cause a breakdown and generate an arc, and may lead to deformation of the package, sparking and flashing, and the package may even catch fire. This is a safety risk, and may also damage the microwave oven.

US 2018/0189623 proposes a solution to this problem. Here, a shielding layer is provided, and electrically coupled to the antenna across the gap, and overlaying the RFID chip, to limit the voltage across the gap when the antenna is exposed to microwaves from a microwave oven. However, even though this alleviates the above-discussed safety problem, it makes the production of the RFID tag complex, cumbersome and costly.

There is therefore still a need for an improved RFID tag which can be microwaved without safety risks and the other problems discussed in the foregoing.

### SUMMARY

It is therefore an object of the present invention to provide an RFID tag and a packaging for a microwaveable food item comprising such an RFID tag, which alleviates at least part of the above-discussed problems, and at least partially address one or more of the above-mentioned needs.

This object is obtained by means of an RFID tag and a packaging in accordance with the appended claims.

According to a first aspect of the invention, there is provided an RFID tag comprising:

a dielectric substrate having a first side and an opposite second side; an antenna arranged on the first side of said dielectric substrate, the antenna defining a gap and configured to operate at an operation frequency;

an RFID chip electrically coupled to the antenna across the gap; and

a shielding conductor arranged on the second side of the dielectric substrate, and preferably underlaying the gap, wherein the shielding conductor is configured to limit the voltage across the gap when the antenna is exposed to a microwave frequency of a microwave oven.

The present invention is based on the realization that by provision of a shielding conductor beneath the gap, and separated from the gap and the antenna by the dielectric substrate on which the antenna is arranged, voltage build-up by microwaves in a microwave oven can be greatly reduced. Due to the closeness of the shielding conductor and the antenna sections forming the gap, the resulting capacitance is high, which effectively forms a low impedance path for frequencies used in microwave ovens, such as at approximately 2.45 GHz. Thus, this high frequency current will bypass the gap, via the shielding conductor, and thereby prevent voltage build-up over the gap. At the same time, since the frequencies used for operation of the RFID tag, such as frequencies within the UHF band, i.e. approximately in the range of 860-960 MHz, RF current flow at such frequencies are not provided with a low impedance path across the gap, and are not short-circuited to the shielding conductor, and are still stopped from propagation over the gap. Thus, by using such a shielding conductor, normal operation of the RFID tag at UHF frequencies is not at all affected, and at the same time, the problem of voltage build-up at microwave oven frequencies is greatly alleviated.

Without wanting to be bound by any theory, it is believed that the IC gap and the antenna, and in particular the matching section of the antenna, such as a conductor loop in the middle of the antenna, form an LC resonator circuit. Typical dimensions of UHF antenna including such a matching section and a conventional IC gap have a resonance frequency which is near the microwave band, such as 2.45 GHz. The resonance effect amplifies voltage build-up over the gap and RF currents in the loop. The capacitance provided by the shield conductor moves the resonance frequency of the circuit to a lower frequency, away from the microwave band. This effectively reduce voltage build-up and current amplitude.

Further, the shielding conductor is relatively simple and cost-effective to produce, since it only requires a conductive area to be arranged on the other side of the dielectric already used for the antenna. Alternatively, when used in a packaging, the shielding conductor may be arranged as a metallized layer on the enclosure forming the packaging, and the RFID tag may then be arranged on top of this metallized layer, thereby bringing the shielding conductor to its operative position.

The low impedance path properties for microwave frequencies of the RFID tag can easily be modified and optimized, as is per se well-known for the skilled artisan. For example, a low impedance path at lower frequencies would be obtained by using a thinner dielectric substrate material, whereas a low impedance path at higher frequencies would be obtained by using thicker dielectric substrate materials. In the same way, a greater overlapping area between the shielding conductor and the antenna would provide a low impedance path at lower frequencies, whereas a smaller overlap would provide a low impedance path at higher frequencies. Thus, providing an arrangement which avoids a low impedance path at the normal, operative frequencies of the RFID tag, such as in the UHF band, and provides a low impedance path at higher frequencies, useable for microwaving, such as 2.45 GHz, is a simple routine measure for any dielectric substrate material by optimization of the known design parameters, and in particular optimization of the overlap area and the substrate thickness.

The shielding conductor is preferably arranged to form a low impedance path for electrical waves having a frequency exceeding 2 GHz, such as at frequencies of approximately 2.45 GHz, which corresponds to frequencies conventionally used for microwave ovens.

The shielding conductor is preferably arranged directly underlaying the gap on the first side of the substrate. However, other configurations are also feasible, such as a shielding conductor which only partly underlays the gap, or a shielding conductor arranged close to the gap, but not directly underlaying it, such as e.g. being arranged to wholly or partly encircle the gap.

The antenna may be of many different types, such as a dipole antenna, a monopole antenna, a loop antenna or a slot antenna.

In one embodiment, the antenna may be a dipole antenna, with dipole antenna parts arranged at opposite end areas of the antenna. The antenna and the antenna parts may have various shapes and dimensions, as is per se known in the art. For example, the dipole antenna parts may extend in a generally linear direction, or may extend in a non-linear way, such as in a meandering form or the like. The parts may also be folded or curved, thereby extending in two or more directions. In one embodiment, dipole antenna parts may terminate, with end parts, which may have an enlarged width, at least at some positions. The end parts may e.g. have a generally circular or a generally rectangular shape.

The dipole antenna parts are preferably connected by at least one intermediate part, forming a bridge between the dipole antenna parts. At least one of said at least one intermediate part comprises power feeding areas to be connected to an integrated circuit, the RFID chip. The power feeding areas are separated by the gap, which may be referred to as an IC gap.

The power feeding areas are electrically coupled to the RFID chip, which thereby bridges the gap between the power feeding areas. Thus each power feeding area is arranged to transfer current between a connector of the RFID chip and one of the dipole antenna parts.

The shielding conductor arranged beneath the gap, on the other side of the substrate, is sufficient to avoid voltage build-up over the gap when exposed to microwaves in a microwave oven. Thus, it is preferred that this shielding conductor is the only shielding conductor of the RFID tag. There is consequently no need for additional shielding conductors, e.g. arranged above the RFID chip, which facilitates production, and also makes the RFID tag thinner and more compact. Preferably, the antenna and the shielding conductor are the sole conductive layers of the RFID tag.

The shielding conductor may have various shapes and dimensions. For example, the shielding conductor may be rectangular, but other shapes, such as oval, circular, bone shaped, and the like, are also feasible.

As discussed in the foregoing, the overlapping area between the shielding conductor and the antenna may be optimized to fine tune the low impedance path properties.

In one embodiment, the shielding conductor has a length which is longer than the gap length of the gap and shorter than the length of the antenna. In one embodiment the shielding conductor has a length, in the length direction of the antenna, in the range of 0.5-25 mm, and preferably in the range 2-15 mm, and most preferably in the range 3-10 mm.

In one embodiment, the shielding conductor has a width, in the width direction of the antenna, in the range of 0.5-20 mm, and preferably in the range 1-15 mm, and most preferably in the range 2-8 mm.

In one embodiment, the shielding conductor has a length, in the length direction of the antenna, exceeding the width, in the width direction of the antenna. In such embodiments, the shielding conductor has an elongate shape. The shielding conductor may e.g. have a generally rectangular shape.

However, for certain embodiments, the shielding conductor may have a length dimension exceeding the length of the antenna. Additionally or alternatively, the shielding conductor may have a width dimension exceeding the width of the antenna. Such a large shielding conductor may e.g. be provided as a metallized layer covering the entire second side of the substrate. Alternatively, the shielding conductor may be formed as a metallized layer on an enclosure forming the packaging, whereby the dielectric substrate with the antenna and the RFID chip may be attached to the enclosure on top of the shielding conductor.

The antenna of the RFID tag is preferably configured for operation at the UHF frequency band. In particular, the antenna may be configured for operation at a frequency within the range of 860-960 MHz.

The dielectric substrate can essentially be of any non-conductive material. In one embodiment, the dielectric substrate material is made of at least one of: paper, board, polymer film, textile and non-woven material. In particular, the substrates can be made of paper.

The dielectric substrate preferably has a thickness in the range of 20-300 μm, and preferably in the range 50-200 μm, and more preferably in the range 50-150 μm, and most preferably in the range 70-130 μm, such as 100 μm. However, it is also possible to use even thicker dielectric substrates, such as up to 1 mm, or up to 2 mm, or even thicker. In particular in embodiments where the dielectric substrate is formed by a part of the package, and for example formed by a cardboard layer, the thickness could be in the range of 1-2 mm.

The RFID tags may be either passive, i.e. powered by a reader's electromagnetic field, or active, i.e. powered by an onboard battery.

The antenna and the shielding conductor may be made of any material, as long as the material is conductive. The antenna and the shielding conductor may be made by the same material, but may alternatively be made of different materials. For example, the antenna and/or the shielding conductor may be formed by aluminum, but other metals, such as silver, and alloys may also be used. Forming of the antenna and the shielding conductor on the substrate can be made in various ways, as is per se known in the art, such as by printing with conductive ink, such as silver ink, by first providing a conductive layer on the substrate and subsequently removing or forming this conductive layer into the desired shape, e.g. by means of grinding, cutting, etching or the like.

According to another aspect of the invention there is provided a packaging for a microwaveable food item comprising an enclosure, and the RFID tag as discussed above, secured to the enclosure. The RFID tag may be attached to the enclosure, e.g. by means of adhesive, but may alternatively be formed as an integrated part of the enclosure, in which case the dielectric substrate of the RFID tag may e.g. be formed by the material of the enclosure forming the packaging. Thus, e.g. for production of intelligent packaging products, the antenna of the RFID tag and the shielding conductor may be provided directly on a package material, e.g. in the form of a sheet or a web.

In one embodiment, the shielding conductor of the RFID tag is provided as a metallized layer on the enclosure. The metallized layer may be arranged on a side of the enclosure facing the RFID tag, such as on an outer surface of the enclosure. However, alternatively, the metallized layer may be arranged on a side of the enclosure material being opposite to the side facing the RFID tag. In such an embodiment, the RFID tab may still comprise a separate dielectric substrate layer, which is then attached to the enclosure. However, in such embodiments, the enclosure material, such as a cardboard layer, may in itself function as the dielectric substrate of the RFID tag, thereby eliminating the need for any separate dielectric substrate.

It will be appreciated that the above-mentioned detailed structures and advantages of the first aspect of the present invention also apply to the further aspects of the present invention.

These and other aspects of the invention will be apparent from and elucidated with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic top plan view of an antenna in accordance with a first embodiment;

FIG. 2 is a schematic top plan view of an RFID tag using the antenna of FIG. 1;

FIG. 3 is a cross-sectional view of a part of the RFID tag of FIG. 2;

FIG. 4 is a schematic top plan view of an exemplary antenna in accordance with another embodiment;

FIG. 5 is a schematic perspective view of a microwaveable food item packaging, including an attached RFID tag in accordance with an embodiment;

FIG. 6 is a schematic perspective view of a microwaveable food item packaging, including an RFID tag integrated in the packaging material, in accordance with another embodiment;

FIG. 7 is a partly exploded schematic perspective view of a microwaveable food item packaging in accordance with another embodiment;

FIG. 8 is a partly exploded schematic perspective view of a microwaveable food item packaging in accordance with still another embodiment;

FIGS. 9-10 are field plots from simulations made on RFID tags in accordance with embodiments of the invention, as well as comparative examples, where FIG. 9 illustrates a field plot of the temperature for a comparative example, and FIG. 10 illustrates a field plot for the temperature of an RFID tag in accordance with an embodiment of the invention; and

FIG. 11 is a schematic top plan view of another antenna in accordance with an embodiment, which is similar to the antenna design of FIG. 1, but provided with smoother corners and transitions.

### DETAILED DESCRIPTION OF PREFERRED EMBODIMENTS

In the following detailed description preferred embodiments of the invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations of the invention, such as the thickness of various layers, the relative dimensions of the antenna and the shielding conductor, etc.

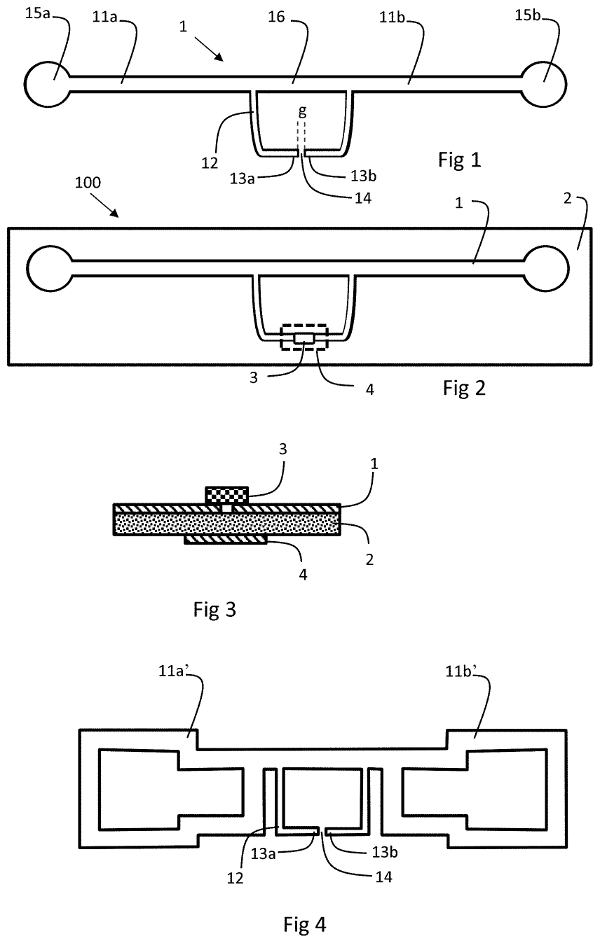

FIG. 1 illustrates an antenna 1 in accordance with an embodiment of the present invention. The antenna is a dipole antenna arranged to be used in an RFID tag, and is preferably arranged to operate in the UHF band.

The antenna 1 comprises two dipole antenna parts 11a and 11b being arranged at opposite end areas of the antenna. The dipole antenna parts are at one of their ends, the ends being closest to each other, connected to a feed arrangement. Here, the feed arrangement is provided in the form of an intermediate part 12 forming a bridge between the dipole antenna parts, and being provided with two power feeding areas 13a and 13b, separated by a gap 14. The first power feeding area 13a is connected to the first dipole antenna part 11a, whereas the second power feeding area 13b is connected to the second dipole antenna part 11b.

The gap length g over the gap may e.g. be in the range of 100-200 μm.

The power feeding areas will, as discussed in more detail in the following, be connected to connectors of an integrated circuit, an RFID chip, which will consequently be arranged overlying and bridging the gap 14.

At the other ends of the dipole antenna parts, not being connected to the power feeding areas, end parts 15a and 15b may be provided. The end parts are preferably provided with smooth, rounded corners, and may e.g. be arranged as generally circular areas. Avoiding of sharp ends prevents voltage build-up.

The two dipole antenna parts 11a and 11b are preferably about equal in size and shape, and are preferably symmetrical with each other.

The dipole antenna parts 11a and 11b are, in the illustrated embodiment, shaped as elongate conductive lines. However, other shapes are also feasible. For example, the part may, at least over a part, extend in a meandering shape. The parts may also have an overall folded or curved shape. Many other shapes are also feasible, as is per se well-known.

Further, the end parts 15a and 15b may have the same width as the rest of the dipole antenna parts. However, preferably, the end parts are somewhat enlarged, having at least partly a greater width. The end parts 15a and 15b are in the illustrative example illustrated as being in the form of circles, but other shapes are also feasible, such as rectangular shapes.

In the illustrative example, the dipole antenna parts are further connected through a further intermediate part 16, for impedance matching. However, in other antenna designs, such additional intermediate parts may take other shapes, or may even be omitted.

In FIG. 4, an alternative antenna design is illustrated. Here, the intermediate parts 12 and 16, with the two power feeding areas 13a and 13b, separated by a gap 14, are similar to the first embodiment. However, in this embodiment, the dipole antenna parts 11a′ and 11b′ are formed as closed loops.

It is generally preferred to avoid sharp edges and corners in the antenna, to avoid points of possible power build-up. Thus, the antenna is preferably provided with an overall smooth design, with rounded or beveled corners and transitions between different parts. An example of such a smooth antenna design is shown in FIG. 11. This antenna design is similar to the antenna design of FIG. 1, but where all the corners and transitions have been smoothened.

In FIG. 2, an RFID tag using the antenna of FIG. 1 is illustrated. The RFID tag 100 here comprises the above-discussed antenna 1 arranged on a substrate 2, and an integrated circuit, an RFID chip 3, is arranged on the antenna, and connected to the power feeding areas 13a and 13b, so that the RFID chip bridges the gap 14.

Underneath the gap and the RFID chip 3, a shielding conductor 4 is provided, shown in dashed lines, arranged on the opposite side of the dielectric substrate 2.

This arrangement is further illustrated in FIG. 3, showing the substrate 2, with the antenna 1 arranged on the first, upper side of the dielectric substrate, and with the RFID chip arranged on top of the antenna, and with the shielding conductor 4 arranged on the second, lower side of the dielectric substrate.

The shielding conductor arranged in this way, separated from the power feeding areas of the antenna by the thin dielectric substrate, provides a low impedance path bypassing the gap at high frequencies. When exposed to microwaves in a microwave oven, which typically have a frequency much greater than the frequencies of the UHF band, such as 2.45 GHz, there would normally be a significant power build-up over the gap. However, due to the shielding conductor, arranged separated from the antenna by the dielectric substrate, the resulting capacitance between the antenna and the shielding conductor is high, which forms a low impedance path at microwave frequencies, which effectively short-circuits RF current flow at frequencies used in microwave ovens, such as at approximately 2.45 GHz. At the same time, since the frequencies used for operation of the RFID tag, such as frequencies within the UHF band, i.e. approximately in the range of 860-960 MHz, RF current flow at such frequencies are not provided with a low impedance path across the gap, and are not short-circuited, and are still stopped from propagation over and around the gap.

The dielectric substrate can essentially be of any non-conductive material, such as paper, board, polymer film, textile and non-woven material. In particular, the substrates can be made of paper.

The antenna and shielding conductor may be made of any material, as long as the material is conductive. The antenna and the shielding conductor may be made of the same material, but different materials may also be used. For example, the antenna and/or the shielding conductor may be formed by aluminum, but other metals, such as silver, and alloys may also be used. For example, it is feasible to use an alloy having a relatively low melting temperature, such as an alloy comprising tin and bismuth. Forming of the antenna on the substrate can be made in various ways, as is per se known in the art, such as by printing with conductive ink, such as silver ink, by first providing a conductive layer on the substrate and subsequently removing or forming this conductive layer into the desired antenna shape, e.g. by means of grinding, cutting, etching or the like.

The RFID chip 3 may take any of a number of forms (including those of the type commonly referred to as a “chip” or a “strap” by one of ordinary skill in the art), including any of a number of possible components and being configured to perform any of a number of possible functions. Preferably, the RFID chip includes an integrated circuit for controlling RF communication and other functions of the RFID tag.

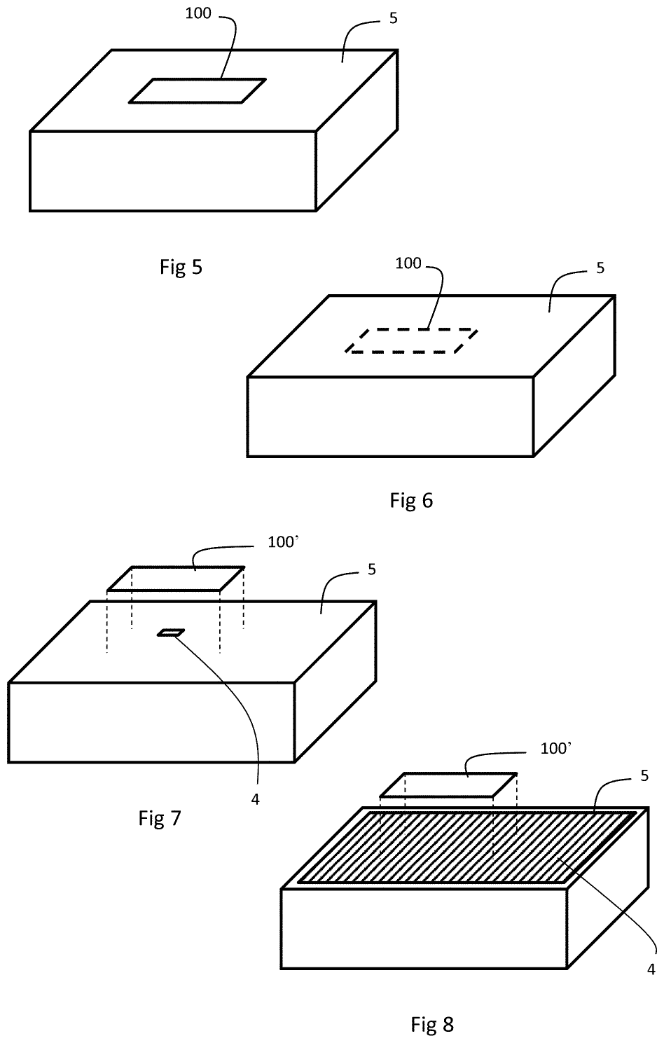

The RFID is particularly suited for use in packaging for a microwaveable food. The RFID tag 100 may hereby be attached to the enclosure 5 forming the package, e.g. by means of adhesive, as schematically illustrated in FIG. 5. Alternatively, the RFID tag 100 may be formed as an integrated part of the enclosure 5, in which case the dielectric substrate of the RFID tag may e.g. be formed by the material of the enclosure forming the packaging, as schematically illustrated in FIG. 6. Thus, e.g. for production of intelligent packaging products, the antenna of the RFID tag may be provided directly on a package material, e.g. in the form of a sheet or a web. In embodiments where the package material serves as the dielectric substrate of the RFID tag, the metallized layer may be arranged on one side of the enclosure material, such as on the inside of the package, and the antenna of the RFID tag be arranged on the opposite side, such as on the outside of the package.

It is also feasible to provide the shielding conductor 4 directly on the surface of the enclosure 5, and then to arranged the RFID tag 100′, not yet provided with a shielding conductor, on top of the shielding conductor. Such an embodiment is schematically illustrated in the exploded view of FIG. 7.

In the so far discussed exemplary embodiments, the shielding conductor has the shape of an elongate rectangle, with the longest side extending in the length direction of the antenna. The shielding conductor is dimensioned to cover the gap with a margin, and preferably at least partly the power feeding areas. On the other hand, the shielding conductor is preferably much smaller than the antenna, and does preferably not extend into the dipole antenna parts.

However, other shapes and dimensions are also feasible. For example, the shielding conductor may be provided with rounded corners, and may also be of other shapes, such as circular, oval, and the like. The shielding conductor may also have a waist, and have wider areas towards the ends, and a narrower width in the middle. As one example, the shielding conductor may be bone shaped.

In other embodiments, the shielding conductor may also have greater dimensions, and may e.g. generally be of the same dimensions as the antenna, or even have greater dimensions than the antenna. One such embodiment is illustrated in FIG. 8. Here, the shielding conductor is provided as a metallized layer on the enclosure 5 of the packaging, and extends over essentially the whole side surface on which the RFID tag 100′ is to be positioned, in the same way as discussed above in relation to FIG. 7.

The enclosure of the packaging may e.g. be in the form of a box of paper or plastic material. Further, while RFID tags are described herein as being incorporated into the packaging of a microwavable food item, it should be understood that RFID tags according to the present disclosure may be useful in any of a number of possible applications, particularly when it is contemplated that they may be exposed to frequencies that are significantly higher than the frequency at which an antenna of the RFID tag is intended to operate.

To evaluate the new concept a number of experimental tests and simulations have been performed.

In a first line of testing, an RFID tag with an antenna made of aluminum and of the general type discussed in relation to FIG. 4, with an IC gap of 160 μm, was attached to a side made of paper of a conventional microwaveable food item. The food item was exposed to microwaves in a microwave oven of the type Samsung MS23K3523AK, with a moving rotation table. The microwave oven was operated at full power, 800 W, for 60 s.

After exposure to the microwaves, it was noted that the paper darkened significantly and became burnt in an area close to the IC gap of the antenna.

The same test was also conducted with an RFID tag in accordance with the invention. For this test, the RFID tag and antenna were identical to the RFID tag and antenna of the first test, but with a shielding conductor arranged underneath the IC gap, on the other side of the substrate. The shielding conductor was about 1 cm in width and a few cm in length. After the same type of microwave exposure, it was found that no darkening or discoloration appeared on the paper of the package enclosure.

Conceptual tag antenna simulations have also been made. For these simulations, an antenna of the type disclosed in relation to FIG. 1 was used. The gap here had a gap length of 200 μm, and the substrate had a thickness of 100 μm. In the inventive example, a rectangular shield conductor having a length of 6 mm and a width of 4 mm was arranged underneath the gap, on the opposite side of the substrate. In the comparative example, no shielding conductor was provided.

In the simulations, an exposure to microwaves of 2.45 GHz was simulated, and with a power and time period corresponding to the radiation in a microwave oven operated at 1000 W for 60 s duration.

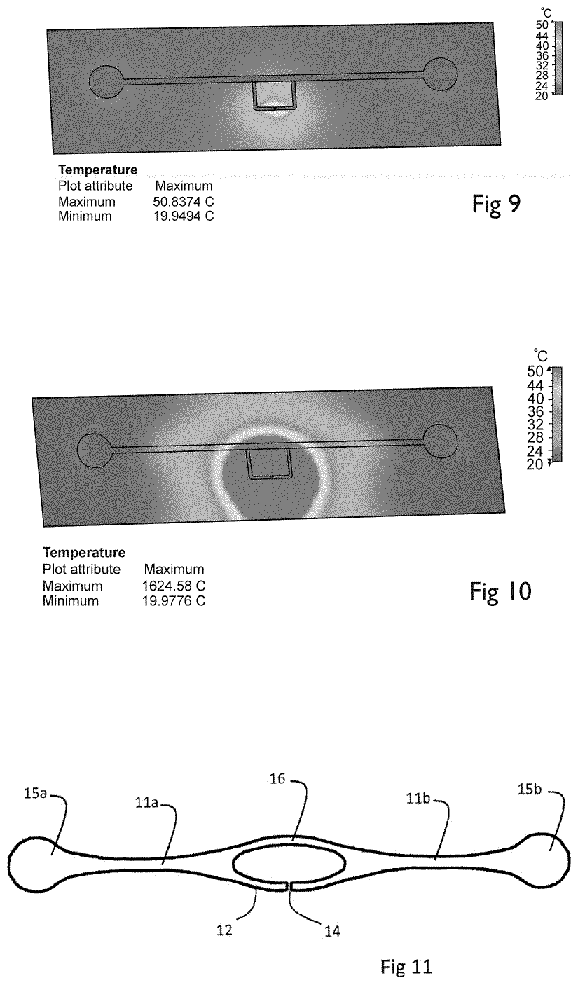

Field plots of these simulations are shown in FIGS. 9 and 10. FIG. 9 illustrates a field plot for the comparative example, having no shielding conductor, and illustrates the temperature over the entire antenna. FIG. 10 illustrates a field plot for the inventive example, having a shield conductor, and also illustrate temperature over the antenna.

In the field plot of FIG. 8 it can be seen that an area of very high temperature is present in a wide circle around the IC gap. The maximum temperature, occurring in the center of this circle, i.e. beneath the IC gap, exceeds 1600 deg. C., whereas the minimum temperature, at a distance from the IC gap, is the same as ambient room temperature, about 20 deg. C.

In the field plot of FIG. 9 it can be seen that the temperature is low over the entire antenna, and only a very limited temperature increase has occurred in the vicinity of the IC gap. The maximum temperature, occurring close to the IC gap, is about 50 deg. C., only slightly higher than the minimum temperature, at a distance from the IC gap, which is the same as ambient room temperature, about 20 deg. C.

From this it can be concluded that the shielding conductor arranged beneath the IC gap dramatically reduces the temperature obtained during exposure to microwaves in a microwave oven. The very high temperature reached in the comparative examples indicates a clear safety hazard. The ignition temperature, i.e. the temperature at which something catches fire and burn on its own, is naturally different for different materials. Ordinary paper has an ignition temperature of about 233 deg. C. However, even though many materials used in packaging for microwaveable food items and the like have a higher ignition temperature, the maximum temperature seen in the comparative examples is well above the ignition temperature for most conventional packaging materials. On the other hand, the temperature in the inventive examples is very low, and is even much lower than the temperature to which food is conventionally heated in microwave ovens. The temperature of the inventive examples is also much below the ignition temperature of all feasible packaging materials.

The above-discussed simulations show relative temperature differences when assuming a simple microwave source relatively close to the RFID tag. Naturally, the environment within a real world microwave oven is much more complex, and the absolute temperature levels may to some extent differ from the simulated cases. However, the simulations nonetheless clearly show the dramatic lowering of the temperatures obtained by the provision of the shielding conductor.

To improve safety even further, the dielectric substrate may be of a non-flammable material. It is also feasible to make the enclosure/package of a non-flammable material, at least in parts adjacent to the RFID tag, or parts forming a part of the RFID tag, in case the enclosure material carries the shielding conductor as a metallized layer, and/or form the dielectric substrate of the RFID tag.

The person skilled in the art realizes that the present invention is not limited to the above-described embodiments. For example, the general antenna design may be varied in many ways, as is per se well-known in the art. The antenna may further be adapted for different operational frequencies.

The shielding conductor arranged on the other side of the substrate may also have various shapes and dimensions.

Such and other obvious modifications must be considered to be within the scope of the present invention, as it is defined by the appended claims. It should be noted that the above-described embodiments illustrate rather than limit the invention, and that those skilled in the art will be able to design many alternative embodiments without departing from the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. An RFID tag comprising:
a dielectric substrate having a first side and an opposite second side;
an antenna arranged on the first side of said dielectric substrate, the antenna defining a gap and configured to operate at an operation frequency;
an RFID chip electrically coupled to the antenna across the gap; and
a shielding conductor arranged on the second side of the dielectric substrate, and preferably underlaying the gap, wherein the shielding conductor is configured to limit the voltage across the gap when the antenna is exposed to a microwave frequency of a microwave oven.

2. The RFID tag of claim 1, wherein the shielding conductor is the only shielding conductor of the RFID tag.

3. The RFID tag of claim 1, wherein the antenna and the shielding conductor are the sole conductive layers of the RFID tag.

4. The RFID tag of claim 1, wherein the shielding conductor has a length which is longer than the gap length of said gap and shorter than the length of the antenna.

5. The RFID tag of claim 1, wherein the shielding conductor has a length, in the length direction of the antenna, in the range of 0.5-25 mm.

6. The RFID tag of claim 1, wherein the shielding conductor has a width, in the width direction of the antenna, in the range of 0.5-20 mm.

7. The RFID tag of claim 1, wherein the shielding conductor has a length, in the length direction of the antenna, exceeding the width, in the width direction of the antenna.

8. The RFID tag of claim 1, wherein the shielding conductor has a generally rectangular shape.

9. The RFID tag of claim 1, wherein the shielding conductor has a length dimension exceeding the length of the antenna.

10. The RFID tag of claim 1, wherein the shielding conductor is arranged to form a low impedance path bypassing the gap for electrical waves having a frequency exceeding 2 GHz.

11. The RFID tag of claim 1, wherein the antenna is configured for operation at the UHF frequency band.

12. The RFID tag of claim 1, wherein the antenna is configured for operation at a frequency within the range of 860-960 MHz.

13. The RFID tag of claim 1, wherein the dielectric substrate s made of at least one of: paper, board, polymer film, textile and non-woven material.

14. Packaging for a microwaveable food item comprising:
an enclosure; and
the RFID tag in accordance with claim 12 secured to the enclosure.

15. The packaging of claim 14, wherein the shielding conductor of the RFID tag is provided as a metallized layer on said enclosure.

16. The RFID tag of claim 1, wherein the shielding conductor has a length, in the length direction of the antenna, in the range of 3-10 mm.

17. The RFID tag of claim 1, wherein the shielding conductor has a width, in the width direction of the antenna, in the range of 2-8 mm.
